(19) United States
(12) Patent Application Publication
(10) Pub. No.: US 2008/0068546 A1
(43) Pub. Date: Mar. 20, 2008

(54) Liquid crystal device and electronic apparatus

(75) Inventors: Takanori Ninomiya, Fujimi-machi (JP); Kosuke Chidate, Chino-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 11/901,489

(22) Filed: Sep. 18, 2007

(30) Foreign Application Priority Data
Sep. 20, 2006 (JP) 2006-253822

(51) Int. Cl. G02F 1/13363

(52) U.S. Cl. 349/119

(57) ABSTRACT

Disclosed herein is a liquid crystal device including: a first substrate and a second substrate; a liquid crystal layer interposed between the first substrate and the second substrate; a first optical compensation film formed of an inorganic material; and a second optical compensation film formed of an inorganic material.

### BACKGROUND

1. Technical Field

The present invention relates to a liquid crystal device such as a liquid light valve and an electronic apparatus including the liquid crystal device, such as a liquid crystal projector.

2. Related Art

In a liquid crystal device, in order to increase use efficiency of incident light, a combination of a micro lens array and a micro lens array plate may be used. In this case, light which is vertically made incident on a liquid crystal layer is obliquely made incident on the liquid crystal layer by changing an angle, in order to condense light using the micro lens array. When the light is obliquely made incident on the liquid crystal layer, a phase is deviated. Thus, contrast deteriorates and a viewing angle becomes narrow.

From such a background, in a liquid crystal device including a micro lens array, an optical phase difference compensating element is used. For example, in a liquid crystal projector disclosed in JP-A-2002-131750, a film formed of an organic material is used as the optical phase difference compensating element. In JP-A-2002-14345, discotic liquid crystal is used as the optical phase difference compensating element. In JP-A-2004-151252, a structural birefringence body formed of an inorganic material has been disclosed. By compensating for an optical phase difference using these optical phase difference compensating elements, it is possible to prevent deterioration in contrast and to enlarge a viewing angle.

However, the film using the organic material disclosed in JP-A-2002-131750 or the discotic liquid crystal disclosed in JP-A-2002-14345 is susceptible to cause deterioration due to ultraviolet rays, resulting in a deterioration in quality. In the technology disclosed in JP-A-2004-151252, since light which passes through the optical compensating element formed of the inorganic material is directly made incident on the liquid crystal layer, the phase difference of liquid crystal molecules can be efficiently compensated, but a process is complicated due to the structure thereof and thus practical realization is difficult.

### SUMMARY

An advantage of some aspects of the invention is that it provides a liquid crystal device capable of compensating for a phase difference which occurs in a liquid crystal layer, and being easily manufactured while achieving excellent durability, space saving and cost reduction.

According to an aspect of the invention, there is provided a liquid crystal device including a first substrate and a second substrate; a liquid crystal layer interposed between the first substrate and the second substrate; a first optical compensation film formed of an inorganic material; and a second optical compensation film formed of an inorganic material.

According to the liquid crystal device of this aspect of the invention, the first substrate is, for example, a counter substrate provided at the light incident side of the liquid crystal device. The second substrate is, for example, a device substrate or a TFT array substrate provided at a light emission side of the liquid crystal device. The first optical compensation film is provided so as to face the first substrate at the light incident side of the liquid crystal device. The second optical compensation film is provided so as to face the first substrate at the light emission side of the liquid crystal device. Accordingly, it is possible to perform two-step optical compensation using the first optical compensation film and the second optical compensation film. That is, at the time of the operation of the liquid crystal device, when light such as projection light is incident to the liquid crystal device functioning as a liquid crystal light valve, compensation corresponding to the first substrate is performed by the first optical compensation film. Next, compensation corresponding to the second substrate is performed by the second optical compensation film. By such compensations, it is possible to prevent light from being incident to the liquid crystal layer in a phase-shifted state and, at the same time, to prevent light passing through the liquid crystal layer from being incident to a light emission side polarization plate in a phase-shifted state. That is, the phase shifting of the light which occurs by passing through an optical device such as a micro lens array located at the light incident side of the liquid crystal device can be compensated by the first optical compensation film. In addition, the phase shifting of the light which occurs by passing through the liquid crystal molecules which are present in the vicinity of the interface of the liquid crystal layer or do not completely rise at the time of intermediate tone display can be compensated by the second optical compensation film. Since the phase is compensated twice, the phase shifting is reduced compared with a case where an optical device for causing phase shifting is provided in addition to the liquid crystal layer, and more particularly, a case where the compensation is performed once.

Since the first optical compensation film and the second compensation film are formed of the inorganic material, deterioration due to ultraviolet rays does not occur. Accordingly, it is possible to improve the durability of the optical compensation film and deterioration of quality with time.

Two phase differences including a phase difference which occurs in the micro lens array and a phase difference which occurs in the liquid crystal layer can be simultaneously compensated. Accordingly, for example, in the light emission side polarization plate, a probability that light is leaked is very low. Thus, it is possible to efficiently prevent deterioration of contrast or reduction of a viewing angle.

In this aspect of the invention, the first optical compensation film may be provided such that a compensation direction for compensating for light incident to the first optical compensation film corresponds to an alignment direction of the first substrate, and the second optical compensation film may be provided such that a compensation direction for compensating for light incident to the second optical compensation film corresponds to an alignment direction of the second substrate.

Since the compensation direction of the first optical compensation film corresponds to the alignment direction of the first substrate, it is possible to suitably perform compensation with respect to the light incident to the liquid crystal layer. Since the compensation direction of the second optical compensation film corresponds to the alignment direction of the second substrate, it is possible to suitably perform compensation with respect to the light emitted from the liquid crystal layer. Accordingly, for example, in the light emission side polarization plate, a probability that light is leaked is very low. Thus, it is possible to efficiently prevent deterioration of contrast or reduction of a viewing angle.

In this aspect of the invention, the first optical compensation film and the second optical compensation film may be arranged such that the compensation directions thereof form an angle of 80 degrees to 100 degrees.

Since the first optical compensation film and the second optical compensation film form the angle of 90 degrees, in a twisted nematic (TN) type liquid crystal device in which the light incident side polarization plate and the light emission side polarization plate are aligned to form 90 degrees with each other, it is possible to suitably perform compensation according to a direction in which the light is twisted. If the angle between the first and second optical compensation films is less than 80 degrees, the polarization of the polarization plate and the compensation of the first and second optical compensation films are not efficiently or suitably performed. In contrast, if the angle between the first and second optical compensation films is greater than 100 degrees, the polarization of the polarization plate and the compensation of the first and second optical compensation films are not efficiently or suitably performed. By this configuration, since the angle between the first and second optical compensation films is in a range from 80 degrees to 100 degrees, it is possible to efficiently prevent deterioration of contrast or reduction of a viewing angle, in the TN type liquid crystal device.

In this aspect of the invention, the first optical compensation film may be provided at a light incident side of the first substrate, and the second optical compensation film may be provided at a light emission side of the second substrate.

By this configuration, it is possible to perform two-step optical compensation of the light incident side of the first substrate and the light emission side of the second substrate using the first optical compensation film and the second optical compensation film. That is, when light such as projection light is incident to the liquid crystal device, compensation is performed with respect to the light incident to the first substrate by the first optical compensation film. That is, the light incident to the first substrate becomes linearly polarized light. Next, compensation is performed with respect to the light from the second substrate by the second optical compensation film. That is, the light emitted from the second substrate becomes linearly polarized light. By such compensations, it is possible to prevent light from being incident to the liquid crystal panel in a phase-shifted state and, at the same time, to prevent light passing through the liquid crystal panel from being incident to a light emission side polarization plate in a phase-shifted state. That is, the phase shifting of the light which occurs by passing through an optical device such as a micro lens array located at the light incident side of the liquid crystal device can be compensated by the first optical compensation film. In addition, the phase shifting of the light which occurs by passing through the liquid crystal molecules which are present in the vicinity of the interface of the liquid crystal layer or do not completely rise at the time of intermediate tone display can be compensated by the second optical compensation film. Since the phase is compensated twice, the phase shifting is reduced compared with a case where an optical device for causing phase shifting is provided in addition to the liquid crystal layer, and more particularly, a case where the compensation is performed once.

Two phase differences including a phase difference which occurs in the micro lens array and a phase difference which occurs in the liquid crystal layer can be simultaneously compensated. Accordingly, for example, in the light emission side polarization plate, a probability that light is leaked is very low. Thus, it is possible to efficiently prevent deterioration of contrast or reduction of a viewing angle.

In this aspect of the invention, the liquid crystal device may further include first dust-proof glass provided at a light incident side of the first substrate and second dust-proof glass provided at a light emission side of the second substrate, the first optical compensation film is provided on the first dust-proof glass, and the second optical compensation film is provided on the second dust-proof glass.

By this configuration, since the optical compensation film is provided on the surface of the dust-proof glass in addition to protection of the liquid crystal panel by the dust-proof glass, a member or a fixing member for arrangement may not be used. At this time, the first optical compensation film may be provided on the surface of the first dust-proof glass close to the liquid crystal layer or on the surface of the first dust-proof glass far from the liquid crystal layer. In contrast, the second optical compensation film may be provided on the surface of the second dust-proof glass close to the liquid crystal layer or on the surface of the second dust-proof glass far from the liquid crystal layer. Alternatively, the optical compensation films may be provided on both surfaces of the dust-proof glass. Accordingly, it is possible to perform optical compensation while achieving space saving and cost reduction.

In this aspect of the invention, the liquid crystal device may further include a micro lens array provided at a light incident side of the first substrate.

By this configuration, the light bent by the micro lens array can be compensated by the first optical compensation film and the light whose the phase is shifted in the liquid crystal layer can be compensated by the second optical compensation film. The micro lenses have a function for bending light to condense light. When light is obliquely incident to the liquid crystal layer, the phase of the light is shifted and contrast deteriorates. Accordingly, after the light passes through the micro lenses, optical compensation is performed. Since the phase of light is shifted by the liquid crystal layer, contrast deteriorates. That is, it is preferable that optical compensation is performed after the light passes through the liquid crystal layer as well as before the light is incident to the liquid crystal layer. The micro lenses may be provided to be closer to the liquid crystal layer or be farther from the liquid crystal layer than the first optical compensation film. Accordingly, in a liquid crystal device including the micro lenses, when the optical compensation films are provided at the light emission sides of the micro lenses and the liquid crystal display to perform two-step compensation with respect to the incident light, it is possible to efficiently prevent deterioration of contrast and to enlarge a viewing angle.

In this aspect of the invention, the first optical compensation film and the second optical compensation film may be provided at a light emission side of the second substrate, and the first optical compensation film may be provided at a light incident side of the second optical compensation film.

By this configuration, it is possible to compensate for a phase difference of light passing through the liquid crystal panel by the first and second optical compensation films provided at the light emission side of the liquid crystal panel. At this time, in the first optical compensation film, compensation according to the alignment direction of the first substrate is performed. In the second optical compensation film, compensation according to the alignment direction of the second substrate is performed. That is, the phase shifting of the light which occurs by passing through an optical device such as a micro lens array located at the light incident side of the liquid crystal device and the phase shifting of the light which occurs by passing through the liquid crystal molecules which are present in the vicinity of the interface of the liquid crystal layer or do not completely rise at the time of intermediate tone display can be compensated by the first and second optical compensation films provided at the light emission side of the liquid crystal panel. Since two-step compensation is performed with respect to the incident light by providing two optical compensation films at the light emission side of the liquid crystal panel, it is possible to efficiently prevent deterioration of contrast and to enlarge a viewing angle in a liquid crystal device including the micro lenses.

In this aspect of the invention, the first optical compensation film and the second optical compensation film may be provided by coating the inorganic material.

By this configuration, the optical compensation film may be provided by coating the inorganic material at a desired place using a method such as a deposition method. By using this method, it is difficult to cause a problem that the optical compensation film cannot be provided due to the shape of an arrangement place. That is, it is possible to easily arrange the optical compensation film at a desired place, without effort for ensuring the arrangement position.

Since the optical compensation film may not be molded in a film shape in advance, it is possible to reduce the number of manufacturing processes. That is, it is possible to reduce cost.

According to another aspect of the invention, there is provided a liquid crystal device including a first substrate and a second substrate; a liquid crystal layer interposed between the first substrate and the second substrate; a micro lens array provided at a light incident side of the liquid crystal layer; and a first optical compensation film provided at a light emission side of the liquid crystal layer and formed of an inorganic material.

According to the liquid crystal device of this aspect of the invention, the first substrate is, for example, a counter substrate provided at the light incident side of the liquid crystal device. The second substrate is, for example, a device substrate or a TFT array substrate provided at a light emission side of the liquid crystal device. The first optical compensation film is provided so as to face the second substrate at the light emission side of the liquid crystal device. Accordingly, it is possible to perform optical compensation of a phase difference of light bent by the micro lens array which occurs in the liquid crystal layer using the first optical compensation film. That is, at the time of the operation of the liquid crystal device, when light such as projection light is incident to the liquid crystal device functioning as a liquid crystal light valve, the light to be incident to the liquid crystal layer is condensed by the micro lens array. Next, the light passes through the liquid crystal layer and the light emitted from the liquid crystal layer is compensated by the first optical compensation film. By performing the compensation, it is possible to prevent the light passing through the liquid crystal layer from being incident to the light emission side polarization plate in a phase-shift state. That is, the phase shifting of the light which occurs by passing through the micro lens array located at the light incident side of the liquid crystal device and the phase shifting of the light which occurs by passing through the liquid crystal molecules which are present in the vicinity of the interface of the liquid crystal layer or do not completely rise at the time of intermediate tone display can be simultaneously compensated by the first optical compensation film.

Since the first optical compensation film is formed of the inorganic material, deterioration due to ultraviolet rays does not occur. Accordingly, it is possible to improve durability of the optical compensation film and to prevent deterioration of quality with time.

Since the optical compensation film is provided at the light emission side of the liquid crystal layer to perform compensation, two phase differences including a phase difference which occurs in the micro lens array and a phase difference which occurs in the liquid crystal layer can be simultaneously compensated by one optical compensation film. Accordingly, for example, in the light emission side polarization plate, a probability that light is leaked is very low. Thus, it is possible to efficiently prevent deterioration of contrast or reduction of a viewing angle.

In this aspect of the invention, the liquid crystal device may further include a second optical compensation film provided at the light incident side of the liquid crystal layer and formed of an inorganic material.

By this configuration, since the second optical compensation film is provided to face the first substrate at the light incident side of the light crystal device in addition to the first optical compensation film which is provided to face the second substrate at the light emission side of the liquid crystal device, two-step compensation for the phase shifting of the incident light can be performed. The position of the second optical compensation film may be provided at the light incident side and the light emission side of the liquid crystal layer and may be appropriately determined in consideration of the structure of the liquid crystal device and the compensation effect.

Since the two-step compensation is performed, the phase shifting of the light incident to the light emission side polarization plate is reduced compared with a case of providing only the first optical compensation film. Accordingly, it is possible to prevent deterioration of contrast or to enlarge a viewing angle.

In this aspect of the invention, one of the first and second optical compensation films may be a film for enlarging a viewing angle.

By this configuration, one of the provided optical compensation films is an optical compensation film formed of the inorganic material and the other thereof is another optical compensation film such as a film for enlarging a viewing angle. Accordingly, by arranging the optical compensation films in consideration of the advantages thereof, it is possible to perform efficient optical compensation with respect to incident light while improving durability or reducing cost.

An electronic apparatus according to the invention includes the above-described liquid crystal device.

Since the electronic apparatus of the invention includes the above-described liquid crystal device, it is possible to obtain various electronic apparatuses with high contrast and a wide viewing angle, such as a projection type display device, a television set, a mobile telephone, an electronic organizer, a word processor, a view finder type or monitor-direct-view type video tape recorder, a workstation, a video telephone, a POS terminal, a device comprising a touch panel or the like.

The operations and other advantages of the invention will be apparent from the following embodiments to be described.

### BRIEF DESCRIPTION OF THE DRAWINGS

The invention will be described with reference to the accompanying drawings, wherein like numbers reference like elements.

FIG. 1 is a plan view showing the configuration of a liquid crystal panel according to a first embodiment of the invention.

FIG. 2 is a cross-sectional view taken along line II-II of FIG. 1.

FIG. 3 is a cross-sectional view showing the configuration of a liquid crystal device and a path of incident light according to the first embodiment of the invention.

FIG. 4 is a perspective view showing compensation directions of optical compensation films.

FIG. 5 is a cross-sectional view showing arrangement of liquid crystal molecules in a liquid crystal layer.

FIG. 6 is a cross-sectional view showing the configuration of a liquid crystal device including dust-proof glass and a path of incident light according to a second embodiment of the invention.

FIG. 7 is a cross-sectional view showing the configuration of a liquid crystal device including a micro lens array and a path of incident light according to a third embodiment of the invention.

FIG. 8 is a cross-sectional view showing the configuration of a liquid crystal device including a micro lens array and a path of incident light according to a fourth embodiment of the invention.

FIG. 9 is a cross-sectional view showing the configuration of a liquid crystal device including a micro lens array and a path of incident light according to a fifth embodiment of the invention.

FIG. 10 is a plan view showing the configuration of a projector which is an example of an electronic apparatus including the liquid crystal device.

### DESCRIPTION OF EXEMPLARY EMBODIMENTS

Hereinafter, embodiments of the invention will be described with reference to the accompanying drawings. In the following embodiments, a TFT active-matrix-drive-type liquid crystal device in which a drive circuit is built will be described as an example of a liquid crystal device according to the invention.

### First Embodiment

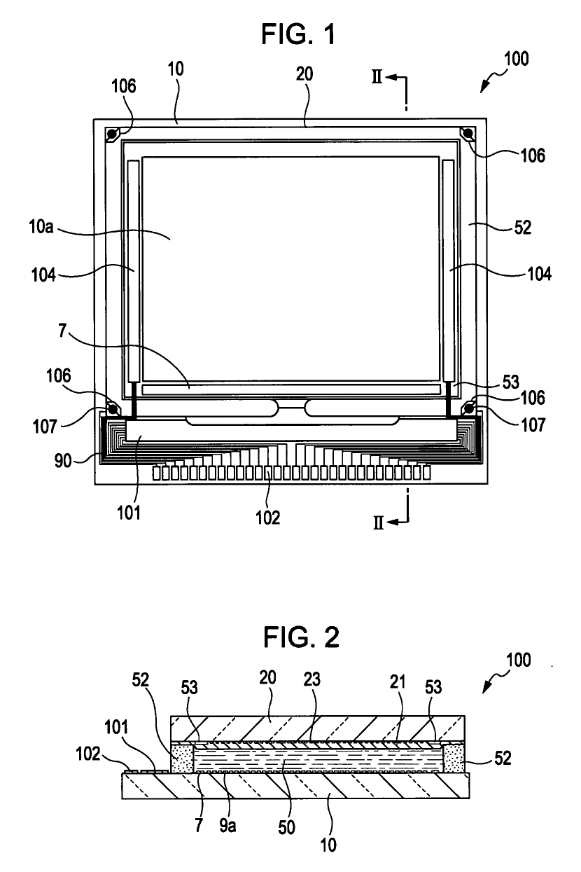

First, a liquid crystal panel 100 configuring a liquid crystal device according to a first embodiment of the invention will be described with reference to FIGS. 1 and 2. FIG. 1 is a plan view showing the configuration of the liquid crystal panel 100 according to a first embodiment of the invention, and FIG. 2 is a cross-sectional view taken along line II-II of FIG. 1. In FIGS. 1 and 2, an optical compensation film which will be described in detail later is not shown and only the liquid crystal panel 100 is shown.

In FIGS. 1 and 2, in the liquid crystal device according to the present embodiment, a TFT array substrate 10 and a counter substrate 20 face each other. A liquid crystal layer 50 is filled between the TFT array substrate 10 and the counter substrate 20. The TFT array substrate 10 and the counter substrate 20 are adhered to each other by a seal material 52 provided in a seal region located at the circumference of an image display region 10a.

In FIG. 1, a frame light-shielding film 53 for defining a frame region of the image display region 10a is provided on the counter substrate 20 inside the seal region, in which the seal material 52 is provided, in parallel to the seal region. In a region located outside the seal region, in which the seal region 52 is provided, among peripheral regions, a data line drive circuit 101 and an external circuit connection terminal 102 are provided along one side of the TFT array substrate 10. A sampling circuit 7 is provided so as to be covered with the frame light-shielding film 53 at the inside of the seal region along one side. Scanning line drive circuits 104 are provided so as to be covered with the frame light-shielding film 53 at the inside of the seal region along two sides adjacent to the one side. Further, on the TFT array substrate 10, upper and lower conducting terminals 106 to serve as upper and lower conduction materials 107 between the two substrates are provided at regions opposite to four corners of the counter substrate 20. Through these members, the electrical conduction is made between the TFT array substrate 10 and the counter substrate 20.

On the TFT array substrate 10, pulled wires for electrically connecting the external circuit connection terminal 102, the data line drive circuit 101, the scanning line drive circuits 104, and the upper and lower conduction terminals 106 are formed.

In FIG. 2, a lamination structure having thin-film transistors (TFTs) for pixel switching, which are drive elements, and wiring lines such as scanning lines and data lines is formed on the TFT array substrate 10. In the image display region 10a, pixel electrodes 9a are provided in a matrix on the TFTs for pixel switching and the wiring lines such as the scanning lines and the data lines. An alignment layer (not shown) is formed on the pixel electrodes 9a. The light-shielding film 23 is formed on the surface of the counter substrate 20 opposite the TFT array substrate 10. The light-shielding film 23 is, for example, formed of a light-shielding metal film and is, for example, patterned in a lattice shape in the image display region 10a of the counter substrate 20. On the light-shielding film 23, counter electrodes 21 formed of a transparent material are formed to face the plurality of pixel electrodes 9a in a solid shape. An alignment film is formed on the counter electrodes 21. The liquid crystal layer 50, which is formed of, for example, one kind of nematic liquid crystal or a mixture of plural kinds of nematic liquid crystal, takes a predetermined alignment state between a pair of alignment layers.

Although not show herein, on the TFT array substrate 10, a test pattern or a test circuit for testing the quality of the liquid crystal device or for testing the liquid crystal device for defects before delivery or during manufacture may be formed in addition to the data line drive circuit 101 and the scanning line drive circuit 104.

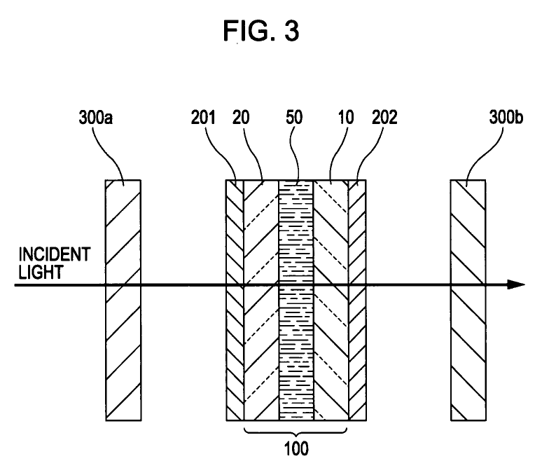

Next, the optical compensation film according to the present embodiment will be described with reference to FIGS. 3 to 5. FIG. 3 is a cross-sectional view showing the configuration of a liquid crystal device and a path of incident light. First, the position of the compensation film will be described with reference to FIG. 3. In the following drawings, the detailed members of the liquid crystal panel 100 shown in FIGS. 1 and 2 will be omitted and only related members will be shown.

In the liquid crystal device according to the present embodiment, the liquid crystal panel 100 is a twisted nematic (TN) type liquid crystal panel. Polarization plates 300a and 300b are provided with the liquid crystal panel 100 interposed therebetween. A first optical compensation film 201 is interposed between the light incident side polarization plate 300a and the liquid crystal panel 100 and a second optical compensation plate 202 is interposed between the light emission side polarization plate 300b and the liquid crystal panel 100. The first optical compensation film 201 and the second optical compensation film 202 may be integrally configured with the member such as the counter substrate 20 or the TFT array substrate 10 as shown in FIG. 3 or may be integrally configured with a support body which is separately provided. Alternatively, for example, the first optical compensation film 201 and the second optical compensation film 202 may be respectively configured in a seal shape to be attached to any substrate.

The first optical compensation film 201 and the second optical compensation film 202 may be provided by coating an inorganic material on a desired place using a method such as a deposition method. By this method, it is possible to provide the optical compensation film to a member having a complicated shape. In addition, since the optical compensation film need not be formed in a film shape in advance, it is possible to reduce manufacturing cost. Since the first optical compensation film 201 and the second optical compensation film 202 are formed of the inorganic material, deterioration due to strong light such as ultraviolet rays does not occur. Since strong light is always illuminated onto the optical compensation film during use, it is efficient for improving durability.

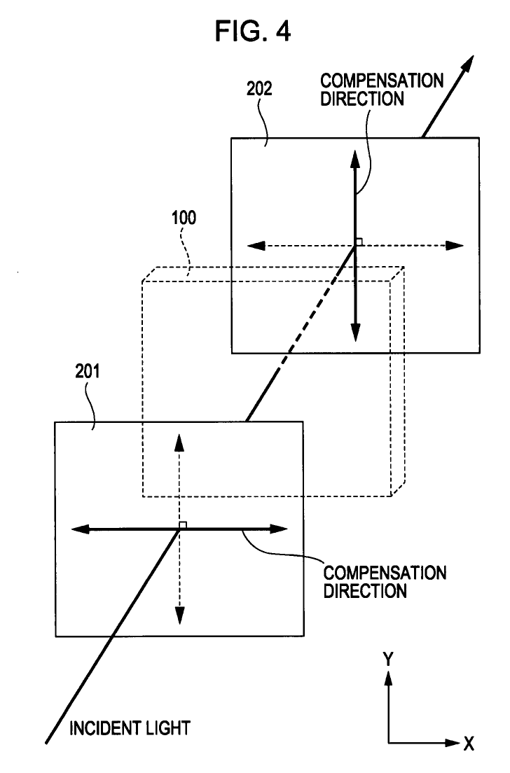

FIG. 4 is a perspective view showing compensation directions of the optical compensation films. The first optical compensation film 201 and the second optical compensation film 202 are arranged such that the compensation directions thereof are perpendicular to each other. For such an arrangement, in the deposition method, deposition processes are performed such that deposition directions are perpendicular to each other. In the first optical compensation film 201, light is compensated in an X direction of FIG. 4 and, in the second optical compensation film 202, the light is compensated in a Y direction. This is because the liquid crystal device according to the present embodiment is of the TN type. In the TN type, since light is twisted in the liquid crystal layer 50, it is preferable that polarizations of lights compensated at a light incident side and a light emission side of the liquid crystal layer 50 differ by 90 degrees. If the liquid crystal device is, for example, of a vertical alignment (VA) type or an in-place-switching (IPS) type instead of the TN type, the optical compensation films are appropriately selected and arranged according to the type of the liquid crystal device.

The first optical compensation film 201 provided at the light incident side of the liquid crystal panel 100 is arranged such that the optical compensation direction thereof corresponds to the alignment direction of the counter substrate 20 (see FIG. 3) provided at the light incident side of the liquid crystal panel 100. For example, the compensation direction of the first optical compensation film 201 is set to correspond to the rubbing direction of the counter substrate 20.

In contrast, the second optical compensation film 202 provided at the light emission side of the liquid crystal panel 100 is arranged such that the optical compensation direction thereof corresponds to the alignment direction of the TFT array substrate 10 (see FIG. 3) provided at the light emission side of the liquid crystal panel 100. For example, the compensation direction of the second optical compensation film 202 is set to correspond to the rubbing direction of the TFT array substrate 10.

For example, the optical compensation direction of the first optical compensation film 201 is arranged in the alignment direction of the counter substrate 20 and the optical compensation direction of the second optical compensation film 202 is arranged in the alignment direction of the TFT array substrate 10.

Returning to FIG. 3, an operation according to the path of the incident light will be described. First, the incident light is incident to the light incident side polarization plate 300a. That is, the incident light is linearly polarized light. The incident light passing through the polarization plate 300a is compensated by the first optical compensation film 201 such that a phase difference is adjusted. The light passing through the first optical compensation film 201 passes through the counter substrate 20 and is incident to the liquid crystal layer 50. At this time, there are liquid crystal molecules which do not completely align as required even when a voltage is applied to the vicinity of the interface of the liquid crystal layer. Hereinafter, the arrangement of the liquid crystal molecules will be described in detail.

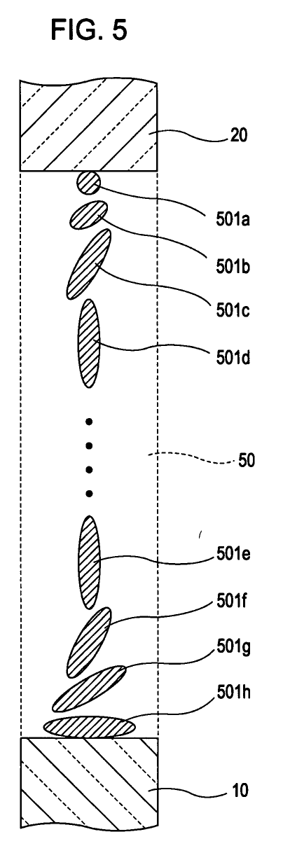

FIG. 5 is a cross-sectional view showing the arrangement of the liquid crystal molecules in the liquid crystal layer. The liquid crystal molecules 501 in the liquid crystal layer 50 are twisted by 90 degrees when the voltage is not applied. When the voltage is applied, the liquid crystal molecules 501 are aligned along an electric field and thus are arranged in a vertical direction (501d and 501e). However, the liquid crystal molecules 501, 501b, 501c, 501f, 501g and 501h in the vicinity of the interface of the liquid crystal layer 50 are not completely arranged in the vertical direction and the long axes of the molecules gradually align toward a central region of the liquid crystal layer 50. Even in intermediate tone display, a plurality of liquid crystal molecules which are not completely arranged in the vertical direction are present. When the linearly polarized light is incident to the liquid crystal liquid 50 in such a state, a phase difference of light occurs and elliptically-polarized light is emitted. That is, if compensation is not performed in this state, contrast may deteriorate.

The light passing through the liquid crystal layer 50 passes through the TFT array substrate 10, is emitted from the liquid crystal panel 100, and is incident to the second optical compensation film 202, as shown in FIG. 3. In the second optical compensation film 202, a phase difference which occurs in the liquid crystal layer 50 is compensated.

The compensated light is incident to the light emission side polarization plate 300b and only light, which is twisted by 90 degrees through the liquid crystal layer 50, passes through the polarization plate 300b.

As described above, since the phase difference of the incident light is compensated by the first optical compensation film 201 and the second optical compensation film 202 to obtain the linearly polarized light, it is possible to efficiently prevent deterioration in the contrast of an image displayed on the liquid crystal device or to enlarge a viewing angle.

### Second Embodiment

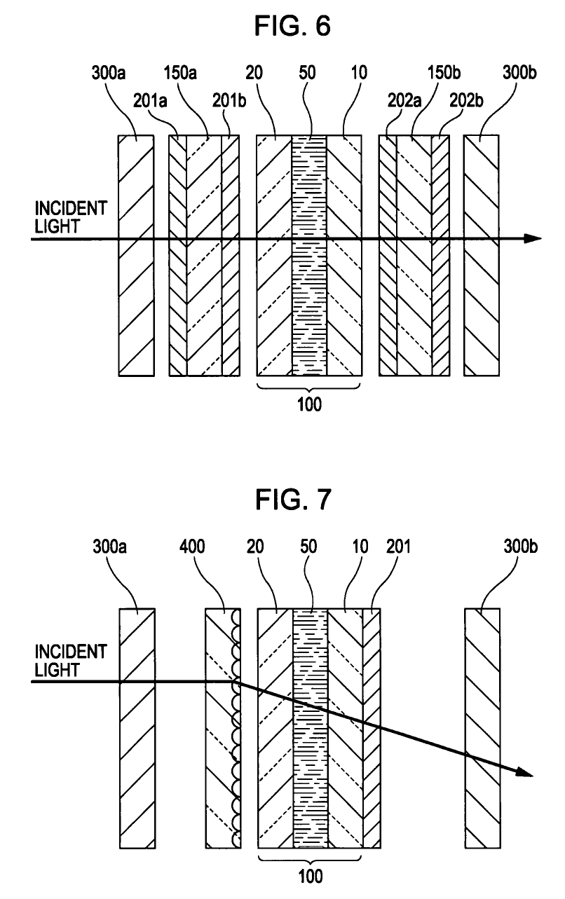

Next, a liquid crystal device according to a second embodiment will be described with reference to FIG. 6. The second embodiment is similar to the first embodiment except for dust-proof glass 150 and the configuration of the optical compensation film. Accordingly, in the second embodiment, the dust-proof glass 150 and the optical compensation film will be described and the other configurations will be omitted. FIG. 6 is a cross-sectional view showing the configuration of a liquid crystal device including the dust-proof glass and a path of incident light.

In the configuration shown in FIG. 6, first dust-proof glass 150a is interposed between the light incident side polarization plate 300a and the liquid crystal panel 100 and second dust-proof glass 150b is interposed between the light emission side polarization plate 300b and the liquid crystal panel 100. First optical compensation films 201a and 201b are provided on both surface of the first dust-proof glass 150a and second optical compensation films 202a and 202b are provided on both surfaces of the second dust-proof glass 150b. At this time, the first optical compensation film 201 or the second optical compensation film 202 may be provided on one surface of the dust-proof glass 150, instead of on the both surfaces of the dust-proof glass 150.

By providing the dust-proof glass 150, it is possible to prevent dust from flowing into the liquid crystal panel 100 to cause a failure. When the first optical compensation film 201 and the second optical compensation film 202 are arranged on the surfaces of the dust-proof glasses 150, a member or a fixing member for arranging the optical compensation films may not be newly used. Accordingly, it is possible to prevent deterioration of contrast or to enlarge a viewing angle by optically compensating for the incident light, while achieving space saving and cost reduction.

### Third Embodiment

Next, a liquid crystal device according to a third embodiment will be described with reference to FIG. 7. The third embodiment is similar to the first embodiment except for a micro lens array 400 and the configuration of the optical compensation film. Accordingly, in the third embodiment, the micro lens array 400 and the optical compensation film will be described and the other configurations will be omitted. FIG. 7 is a cross-sectional view showing the configuration of a liquid crystal device including the micro lens array and a path of incident light.

In the liquid crystal device according to the present embodiment, a micro lens array 400 is interposed between the light incident side polarization plate 300a and the liquid crystal panel 100 and a first optical compensation film 201 is interposed between the light emission side polarization plate 300b and the liquid crystal panel 100.

In the liquid crystal panel 100, the micro lens array 400 is provided on a light incident side region of the liquid crystal layer 50, for improvement of substantial aperture efficiency, that is, improvement of light use efficiency, improvement of brightness, or improvement of color purity. In the micro lens array 400, since the incident light is condensed by the micro lenses, the light is bent. Since the bent light is vertically incident to the liquid crystal layer 50, a phase is apt to be shifted when the light is incident to the liquid crystal layer 50. Accordingly, a phase difference is compensated by providing the first optical compensation film 201 such that the light becomes the linearly polarized light. Accordingly, since the compensated light can be incident to the light emission side polarization plate 300b, it is possible to prevent deterioration of contrast and to enlarge a viewing angle.

In addition, the micro lens array 400 may be built into the liquid crystal panel 100.

### Fourth Embodiment

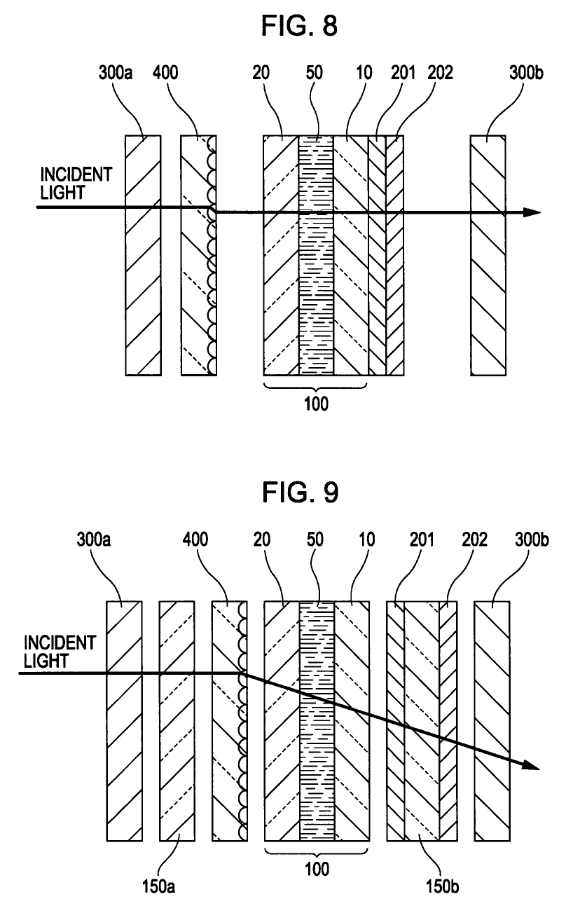

Next, a liquid crystal device according to a fourth embodiment will be described with reference to FIG. 8. The fourth embodiment includes a second optical compensation film 202 provided at a light emission side of a first optical compensation film 201, in addition to the configuration of the third embodiment. Accordingly, in the fourth embodiment, the first optical compensation film 201 and the second optical compensation film 202 will be described and the other configurations will be omitted. FIG. 8 is a cross-sectional view showing the configuration of a liquid crystal device including the micro lens array and a path of incident light.

The optical compensation direction of one of the first optical compensation film 201 and the second optical compensation film 202 corresponds to the alignment direction of the TFT array substrate 10 provided at the light emission side of the liquid crystal layer 50. The optical compensation direction of the other of the first optical compensation film 201 and the second optical compensation film 202 corresponds to the alignment direction of the counter substrate 20 provided at the light incident side of the liquid crystal panel 100.

In more detail, the first optical compensation film 201 corresponds to the TFT array substrate 10 and the second optical compensation film 202 corresponds to the counter substrate 20. By this correspondence, it is possible to improve contrast.

In the liquid crystal device according to the present embodiment, the second optical compensation film 202 is provided in addition to the first optical compensation film 201. The second optical compensation film 202 may be integrally configured with the first optical compensation film 201 as shown in FIG. 8 or may be configured a support body which is separately provided.

Since the first optical compensation film 201 and the second optical compensation film 202 are provided at the light emission side of the liquid crystal panel 100, it is possible to perform two-step compensation with respect to the light passing through the liquid crystal layer 50. Accordingly, the light which is incident to the light emission side polarization plate 300b becomes more perfect linearly polarized light, compared with the case of providing one optical compensation film. Accordingly, it is possible to reduce light leakage in the light emission side polarization plate 300b. Therefore, it is possible to prevent deterioration of contrast and to enlarge a viewing angle.

One of the first optical compensation film 201 and the second optical compensation film 202 may be formed of, for example, a film for enlarging a viewing angle. This is an optical compensation device manufactured by coating a polymer alignment layer on a tri-acetyl cellulose (TAC) film, performing a rubbing process, and coating, aligning and fixing discotic liquid crystal. Since this optical compensation device has an effective characteristic regardless of an arrangement angle in a range of 80 degrees to 100 degrees, the decreasing rate of contrast due to deviation in the arrangement angle is decreased. Since this optical compensation device is a molded product, attachment is performed for arrangement of the device. Cost reduction or work time reduction in a manufacturing process can be achieved.

Accordingly, optical compensation with respective characteristics can be achieved using one optical compensation film formed of the inorganic material and one optical compensation device. For example, when the optical compensation film formed of the inorganic material is arranged at a side which is apt to be affected by ultraviolet rays in structure and the optical compensation device is arranged at the opposite side thereof, it is possible to reduce cost while improving durability. In consideration of the positions or the roles of the optical compensation film formed of the inorganic material and the optical compensation device, the optical compensation film and the optical compensation device are appropriately combined to obtain a plurality of advantages.

### Fifth Embodiment

Next, a liquid crystal device according to a fifth embodiment will be described with reference to FIG. 9. The fifth embodiment is different from the fourth embodiment in the dust-proof glass 150 and the configuration of the optical compensation film. Accordingly, in the fifth embodiment, the dust-proof glass 150 and the optical compensation film will be described and the other configurations will be omitted. FIG. 9 is a cross-sectional view showing the configuration of a liquid crystal device including the micro lens array and a path of incident light.

In the liquid crystal device according to the present embodiment, dust-proof glass 150a is interposed between the light incident side polarization plate 300a and the micro lens array 400 and dust-proof glass 150b is interposed between the liquid crystal panel 100 and the light emission side polarization plate 300b. The first optical compensation film 201 is provided on the surface of the dust-proof glass 150b at the side of the liquid crystal panel and the second optical compensation film 202 is provided on the surface of the dust-proof glass 150b at the side of the polarization plate 300b. The optical compensation direction of the first optical compensation film 201 corresponds to the alignment direction of the counter substrate 20 provided at the light incident side of the liquid crystal layer 50 and the optical compensation direction of the second optical compensation film 202 corresponds to the alignment direction of the TFT array substrate 10 provided at the light emission side of the liquid crystal panel 100. The first and second optical compensation films may be integrally configured with the dust-proof glass 150 as shown in FIG. 9 or may be integrally configured with a support body which is separately provided.

As shown in FIG. 9, since the two optical compensation films, that is, the first optical compensation film 201 and the second optical compensation film 202, are provided at the light emission side of the liquid crystal panel 100, it is possible to perform two-step compensation with respect to the light passing through the liquid crystal layer 50. Accordingly, the light which is incident to the light emission side polarization plate 300b becomes more perfect linearly polarized light, compared with the case of providing one optical compensation film. Accordingly, it is possible to reduce light leakage in the light emission side polarization plate 300b. Therefore, it is possible to prevent deterioration of contrast and to enlarge a viewing angle.

### Electronic Apparatus

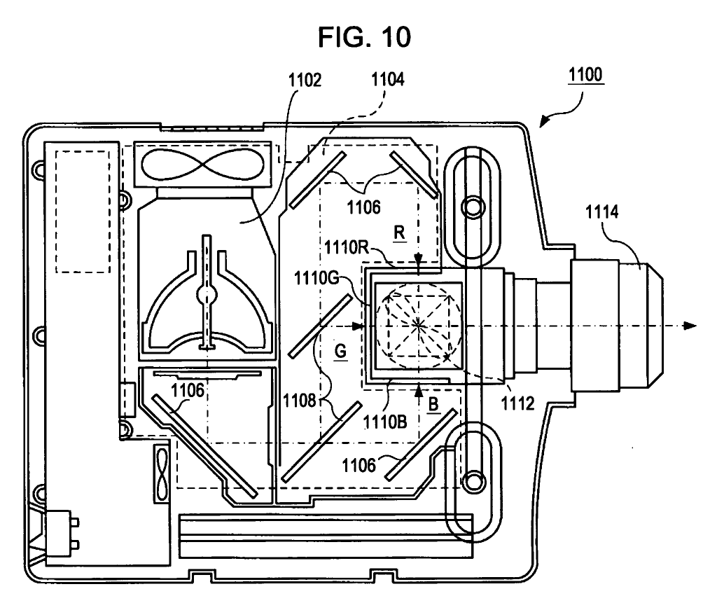

Next, a projector using the above-described liquid crystal device as a light valve will be described. FIG. 10 is a plan view showing the configuration of the projector.

As shown in FIG. 10, a lamp unit 1102 formed of a white light source such as a halogen lamp is provided in the projector 110. The projection light emitted from the lamp unit 1102 is divided into three primary colors of RGB by four mirrors 1106 and two dichroic mirror 1108 provided in a light guide 1104 to be incident to liquid panels 1110R, 1110B and 1110G as light valves corresponding to the primary colors.

The liquid crystal panels 1110R, 1110B and 1110G have the same configuration of the above-described liquid crystal device and are driven by the primary color signals of R, G and B supplied from an image signal processing circuit. The light modulated by the liquid crystal panels is incident to the dichroic prism 1112 in three directions. In the dichroic prism 1112, light of R and B are refracted at 90 degrees and light of G goes straight. Therefore, an image of each color is synthesized, whereby a color image is projected onto a screen or the like through a projector lens 1114.

Here, when attention is focused on a display image by each of the light valves 1110R, 1110B, and 1110G, the display image by the light valve 1110G is needed to be mirror-inversed with respect to the display images by the light valves 1110R and 1110B.

Further, since light corresponding to each of the primary colors is incident to each of the light valves 1110R, 1110B, and 1110G by the dichroic mirrors 1108, there is no need to provide a color filter.

Further, in addition to the electronic apparatus described with reference to FIG. 10, a liquid crystal television, a view finder type or monitor-direct-view type video tape recorder, a car navigation device, a pager, an electronic organizer, an electronic calculator, a word processor, a workstation, a video telephone, a POS terminal, a device comprising a touch panel or the like can be exemplified. Further, it is needless to say that the liquid crystal device of the invention can be applied to the various electronic apparatus described above.

The invention is applicable to a liquid crystal on silicon(LCOS) in which a device is formed on a silicon substrate, in addition to the liquid crystal devices according to the above-described embodiments.

The invention is not limited to the above-described embodiment, and it is to be understood that changes and modifications may be made without departing from the spirit or scope of the invention as defined by the appended claims. The liquid crystal device and the electronic apparatus including the liquid crystal device according to the changes and modifications are also included in the scope of the invention.

The entire disclosure of Japanese Patent Application No. 2006-253822, filed Sep. 20, 2006 is expressly incorporated by reference herein.

What is claimed is:

1. A liquid crystal device comprising:
a first substrate and a second substrate;
a liquid crystal layer interposed between the first substrate and the second substrate;
a first optical compensation film formed of an inorganic material; and
a second optical compensation film formed of an inorganic material.

2. The liquid crystal device according to claim 1, wherein:
the first optical compensation film is provided such that a compensation direction for compensating for light incident to the first optical compensation film corresponds to an alignment direction of the first substrate, and
the second optical compensation film is provided such that a compensation direction for compensating for light incident to the second optical compensation film corresponds to an alignment direction of the second substrate.

3. The liquid crystal device according to claim 1, wherein the first optical compensation film and the second optical compensation film are arranged such that the compensation directions thereof form an angle of 80 degrees to 100 degrees.

4. The liquid crystal device according to claim 1, wherein:
the first optical compensation film is provided at a light incident side of the first substrate, and
the second optical compensation film is provided at a light emission side of the second substrate.

5. The liquid crystal device according to claim 1, further comprising:
first dust-proof glass provided at a light incident side of the first substrate; and
second dust-proof glass provided at a light emission side of the second substrate,
wherein the first optical compensation film is provided on the first dust-proof glass, and
wherein the second optical compensation film is provided on the second dust-proof glass.

6. The liquid crystal device according to claim 1, further comprising a micro lens array provided at a light incident side of the first substrate.

7. The liquid crystal device according to claim 6, wherein:
the first optical compensation film and the second optical compensation film are provided at a light emission side of the second substrate, and
the first optical compensation film is provided at a light incident side of the second optical compensation film.

8. The liquid crystal device according to claim 1, wherein the first optical compensation film and the second optical compensation film are provided by coating the inorganic material.

9. A liquid crystal device comprising:
a first substrate and a second substrate;
a liquid crystal layer interposed between the first substrate and the second substrate;
a micro lens array provided at a light incident side of the liquid crystal layer; and
a first optical compensation film provided at a light emission side of the liquid crystal layer and formed of an inorganic material.

10. The liquid crystal device according to claim 9, further comprising a second optical compensation film provided at the light incident side of the liquid crystal layer and formed of an inorganic material.

11. The liquid crystal device according to claim 10, wherein one of the first and second optical compensation films is a film for enlarging a viewing angle.

12. An electronic apparatus comprising the liquid crystal device according to claim 1.
